(19) United States
(12) Patent Application Publication
(10) Pub. No.: US 2025/0062362 A1
(43) Pub. Date: Feb. 20, 2025

(54) LITHIUM-ION CELLS INCLUDING A COATED CURRENT COLLECTOR AND METHODS OF FORMING THE SAME

(71) Applicant: GM GLOBAL TECHNOLOGY OPERATIONS LLC, Detroit, MI (US)

(72) Inventors: Sayed Youssef Sayed Nagy, Troy, MI (US); Caleb Reese, Ferndale, MI (US); Anil K. Sachdev, Rochester Hills, MI (US); Anita Li, Ann Arbor, MI (US); Xiaosong Huang, Novi, MI (US)

(73) Assignee: GM GLOBAL TECHNOLOGY OPERATIONS LLC, Detroit, MI (US)

(21) Appl. No.: 18/450,617

(22) Filed: Aug. 16, 2023

(51) Int. Cl. H01M 4/66; H01M 4/04; H01M 4/134; H01M 4/1395; H01M 4/38; H01M 10/0525; H01M 10/0585

(52) U.S. Cl. CPC H01M 4/667; H01M 4/0404; H01M 4/0419; H01M 4/045; H01M 4/134; H01M 4/1395; H01M 4/382; H01M 4/663; H01M 4/668; H01M 10/0525; H01M 10/0585; H01M 2004/021; H01M 2004/027; H01M 2220/20

(57) ABSTRACT

Lithium-ion cells and methods for producing such cells are provided. The lithium-ion cells include a lithium metal anode (LMA), a cathode, and an electrolyte between the LMA and the cathode. The LMA includes a current collector and a deformable layer on a surface of the current collector. The deformable layer is lithium-ion conductive and includes a polymeric material. The cathode has a lithium intercalation material. In some examples, lithium metal is plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte.

### INTRODUCTION

The technical field generally relates to lithium-ion batteries, and more particularly relates to lithium-ion batteries that include a current conductor having a deformable layer on a surface thereof.

High-energy-density rechargeable batteries, such as lithium-ion batteries, are used in a plurality of applications including consumer electronics and electric vehicles. While significant improvements to these batteries have been achieved, there are ongoing efforts to produce new battery configurations with improved overall performance and/or reduced size.

Accordingly, it is desirable to provide high-energy-density rechargeable batteries with improved performance and/or reduced size. Furthermore, other desirable features and characteristics of the present invention will become apparent from the subsequent detailed description and the appended claims, taken in conjunction with the accompanying drawings and the foregoing technical field and background.

### SUMMARY

A lithium-ion cell is provided that, in one example, includes a lithium metal anode, a cathode, and an electrolyte between the lithium metal anode and the cathode. The lithium metal anode includes a current collector and a deformable layer on a surface of the current collector. The deformable layer is lithium-ion conductive and includes a polymeric material. The cathode has a lithium intercalation material.

In various examples, the lithium-ion cell is a hostless cell wherein lithium metal is plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte. The deformable layer is configured to reduce interfacial stress acting upon the SEI layer during cycling of the lithium-ion cell.

In various examples, the deformable layer of the lithium-ion cell has a Young's modulus that is less than a Young's modulus of the SEI layer that forms during charge of the lithium-ion cell.

In various examples, the deformable layer of the lithium-ion cell has a thickness of between 5 nanometers to 100 nanometers.

In various examples, the deformable layer of the lithium-ion cell includes polyamide, polyaniline (PANI), polythiophene (PTH), polypyrrole (PPy), polyesters, polyethylenes, a derivative of nitrile butadiene rubber, poly(3,4-ethylenedioxythiophene) (PEDOT), poly(3,4-ethylenedioxythiophene):poly(styrenesulfonate) (PEDOT:PSS), polyphenylene sulfides, polycarbonate, or acrylonitrile butadiene styrene that have been modified by the addition of conductive particles.

In various examples, the deformable layer of the lithium-ion cell includes a conductive polymer hydrogel.

In various examples, the deformable layer of the lithium-ion cell includes polyvinylidene fluoride (PVDF) with carbon nanotubes (CNT), styrene-butadiene rubber (SBR) with CNT, or poly(di-methylsiloxane) (PDMS), polyurethane(PU), polyacrylic acid (PAA) with conductive nanofillers such as metallic nanowires, carbon black, metallic nanoparticles, CNTs, graphene, or conducting polymeric particles.

In various examples, the deformable layer of the lithium-ion cell includes a compound with two or more-OH groups and/or an elastomer in a concentration sufficient to promote mechanical stretchability of the polymer.

A method is provided that, in one example, includes forming a lithium metal anode that includes a deformable layer on a surface of a current collector, wherein the deformable layer is lithium-ion conductive and includes a polymeric material, and assembling the lithium metal anode with a cathode having a lithium intercalation material and an electrolyte between the lithium metal anode and the cathode to define a lithium-ion cell.

In various examples, forming the deformable layer on the current collector includes depositing the polymeric material onto the surface of the current collector by a spin coating or spraying process. In various examples, the method includes controlling the thickness of the deformable layer by controlling the viscosity and concentration of the polymeric material and controlling, during the spin coating or spraying process, a rotational speed of the current collector and a duration of deposition of the polymeric material.

In various examples, forming the deformable layer on the current collector includes depositing the polymeric material onto the surface of the current collector by an electroplating process. In various examples, the method includes controlling the thickness of the deformable layer by controlling the charge per unit area during the electroplating process.

In various examples, wherein the lithium-ion cell is configured to have lithium metal plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte, wherein the deformable layer is configured to reduce interfacial stress acting upon the SEI layer during cycling of the lithium-ion cell, wherein the deformable layer of the lithium-ion cell produced by the method has a Young's modulus that is less than a Young's modulus of the SEI layer that forms during charge of the lithium-ion cell.

In various examples, the deformable layer of the lithium-ion cell produced by the method has a thickness of between 5 nanometers to 100 nanometers.

In various examples, the deformable layer of the lithium-ion cell produced by the method includes polyamide, polyaniline (PANI), polythiophene (PTH), polypyrrole (PPy), polyesters, polyethylenes, a derivative of nitrile butadiene rubber, poly(3,4-ethylenedioxythiophene) (PEDOT), poly(3,4-ethylenedioxythiophene):poly(styrenesulfonate) (PEDOT:PSS), polyphenylene sulfides, polycarbonate, or acrylonitrile butadiene styrene that have been modified by the addition of conductive particles.

In various examples, the deformable layer of the lithium-ion cell produced by the method includes a conductive polymer hydrogel.

In various examples, the deformable layer of the lithium-ion cell produced by the method includes polyvinylidene fluoride (PVDF) with carbon nanotubes (CNT), styrene-butadiene rubber (SBR) with CNT, or poly(di-methylsiloxane) (PDMS), polyurethane (PU), polyacrylic acid (PAA) with conductive nanofillers such as metallic nanowires, carbon black, metallic nanoparticles, CNTs, graphene, or conducting polymeric particles.

In various examples, the deformable layer of the lithium-ion cell produced by the method includes a compound with two or more —OH groups and/or an elastomer in a concentration sufficient to promote mechanical stretchability of the polymer.

A vehicle is provided that, in one example, includes a lithium-ion battery including a lithium-ion cell and a propulsion system configured to receive electric power from the lithium-ion battery. The lithium-ion cell includes a lithium metal anode, a cathode having a lithium intercalation material, and an electrolyte between the lithium metal anode and the cathode. The lithium metal anode includes a current collector and a deformable layer on a surface of the current collector, wherein the deformable layer is lithium-ion conductive and includes a polymeric material. Lithium metal is plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte. The deformable layer has a Young's modulus that is less than a Young's modulus of the SEI layer that forms during charge of the lithium-ion cell. The deformable layer has a thickness of between 5 nanometers to 100 nanometers. The deformable layer is configured to reduce interfacial stress acting upon the SEI layer during cycling of the lithium-ion cell.

### BRIEF DESCRIPTION OF THE DRAWINGS

The exemplary embodiments will hereinafter be described in conjunction with the following drawing figures, wherein like numerals denote like elements, and wherein:

FIGS. 1, 2, and 3 are schematic diagrams presenting an exemplary lithium-ion cell in a uncycled, as-assembled state, a charged state, and a discharged state, respectively, is in accordance with an example;

FIG. 4 is a flow diagram illustrating a method of coating a solid-state electrolyte in accordance with an example; and

FIG. 5 is a functional block diagram of an exemplary vehicle comprising a lithium-ion battery in accordance with an example.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

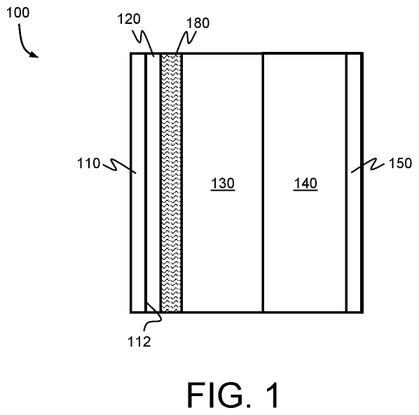

Referring initially to FIGS. 1, 2 and 3, an exemplary lithium-ion cell 100 is presented. The lithium-ion cell 100 may be one of a plurality of lithium-ion cells within a lithium-ion battery. The lithium-ion cell 100 and/or the lithium-ion battery that includes the lithium-ion cell 100 may be used to provide electrical power to various electronic devices, such as but not limited to, electric vehicles, consumer electronics, etc.

The lithium-ion cell 100 includes a lithium metal anode (LMA) that includes a first current collector 110 (also referred to as the anode-side current collector 110), an electrolyte 130, a cathode 140, and a second current collector 150 (also referred to as the cathode-side current collector 150). The LMA includes a deformable layer 120 directly on and in contact with a surface 112 of the anode-side current collector 110. In some examples, the LMA includes a lithium metal layer (either an initial lithium metal layer 180 or a plated layer 160). In some examples, the LMA does not initially include either the initial lithium mental layer 180 or the plated layer 160, that is, lithium ions are stored in the cathode 140.

In this example, the lithium-ion cell 100 is configured as an “anode-free” or “hostless” lithium-ion cell, that is, the lithium-ion cell 100 does not include an anode host material (e.g., graphite) configured as a matrix for receiving and storing lithium-ions (Li⁺) from the cathode 140. Instead, the lithium-ion cell 100 is configured for lithium metal (Li⁰) to be plated directly on the deformable layer 120 during charging of the lithium-ion cell 100, resulting in a plated lithium layer 160 on and in direct contact with the surface 122 of the deformable layer 120, as described in more detail below

The lithium metal anode includes lithium metal as an active anode material. In various examples, in an initial, as-assembled state of the lithium-ion cell 100, the lithium metal anode may include the initial lithium metal layer 180 comprising a lithium metal (e.g., an Li thin film or foil), for example, pressed to the anode-side current collector 110. In some examples, in the initial, as-assembled state of the lithium-ion cell 100, the lithium metal anode does not include a layer of lithium metal. The anode-side current collector 110 may be formed of various materials including those used in the art for lithium-ion anode-side current collectors. In some examples, the anode-side current collector 110 may include or be formed of copper or an alloy thereof. In some examples, the anode-side current collector 110 may be a metal layer (e.g., a thin film or foil).

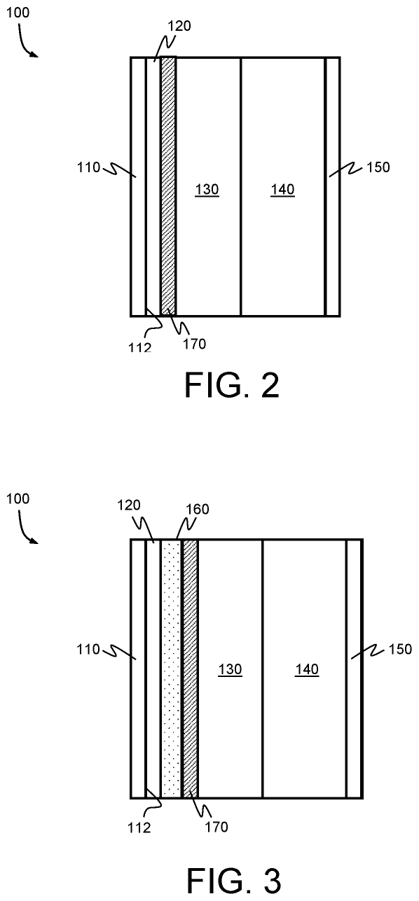

The deformable layer 120 is configured to provide stress mitigation across the surface 112 of the anode-side current collector 110 and thereby reduce a likelihood of damage occurring to a solid electrolyte interphase (SEI) layer 170 that forms between the deformable layer 120 and the electrolyte 130 during operation of the lithium-ion cell 100. In general, the SEI layer 170 is a solid layer that forms inside a lithium battery as it is used (i.e., cycled). During charge and discharge cycles, when electrolyte comes in contact with the electrode, solvents in the electrolyte which are accompanied by the lithium-ions during charging react with the electrode and decompose. This decomposition results in the formation of various compounds such as LiF, LiO, and/or Li₂CO₃. These compounds precipitate on the electrode and form a few nanometer thick passivating layer. This passivating layer protects the electrode from corrosion and further consumption of the electrolyte. In some instances, nucleation of lithium metal on the SEI layer may cause compressive interfacial stresses between the SEI layer and the current collector that can damage or rupture the SEI layer resulting in holes therein. Such holes may function as passages that promote formation of lithium dendrites that can deteriorate performance of lithium-ion cells due, for example, to consumption of electrolyte, and an increased likelihood of soft short circuits. In various examples disclosed herein, the deformable layer 120 is configured to undergo elastic deformation to absorb, reduce, or dissipate local concentrations of interfacial compressive stress between the anode-side current collector 110 and the SEI layer 170 that would otherwise potentially damage the SEI layer 170. In this manner, the SEI layer 170 may be protected from damage and the likelihood of forming lithium dendrites may be reduced. Although FIGS. 2 and 3 show the SEI layer 170 as present in the lithium-ion cell 100, it should be understood that the SEI layer 170 may not be present in the lithium-ion cell 100 in the initial, as-assembled state thereof prior to cycling of the lithium-ion cell 100, as represented in FIG. 1.

To promote preferential deformation of the deformable layer 120 rather than the SEI layer 170, the deformable layer 120 preferably has a Young's modulus that is less than a Young's modulus of the SEI layer 170. In various examples, the deformable layer 120 includes or is formed of a conductive polymeric material, such as a conductive polymer or a nonconductive polymer that includes conductive additives. In various examples, the deformable layer 120 includes or is formed of a conductive polymer such as, but not limited to, certain polyamides, polyaniline (PANI), polythiophene (PTH), polypyrrole (PPy), polyesters, polyethylenes, conductive acrylics such as derivatives of nitrile butadiene rubber (with or without metallic additive species), poly(3,4-ethylenedioxythiophene) (PEDOT), poly(3,4-ethylenedioxythiophene):poly(styrenesulfonate) (PEDOT:PSS), polyphenylene sulfides, polycarbonate, or acrylonitrile butadiene styrene that have been modified by the addition of conductive particles, including carbon-based particles, metal oxides, metal nitrides. In various examples, the deformable layer 120 includes or is formed of a conductive polymer hydrogels (i.e., three-dimensional (3D) polymeric networks) such as, but not limited to, a mixture of PANI and phytic acid (acts as gelator or dopant for conductive polymers). In various examples, the deformable layer 120 includes or is formed of a nonconductive polymer with conductive additives such as, but not limited to, polyvinylidene fluoride (PVDF) with carbon nanotubes (CNTs), styrene-butadiene rubber (SBR) with CNTs, or certain elastomers such as poly(di-methylsiloxane) (PDMS), polyurethane (PU), polyacrylic acid (PAA) with conductive nanofillers such as metallic nanowires, carbon black, metallic nanoparticles, CNTs, graphene, or conducting polymeric particles.

In various examples, the deformable layer 120 may include a polymeric material that includes organic or inorganic additives that promote flexibility thereof. For example, the deformable layer 120 may include a polymeric material that includes an additive that causes plasticization thereof, that is, destruction/disturbance of intermolecular force within the polymer. For example, a compound with two or more —OH groups such as D-sorbitol, glycerol, malic acid, 1,2,6-hexanetriol, triethylene glycol, or certain elastomers such as waterborne polyurethane (WPU) can be used as an additive to enhance the mechanical stretchability of certain conducting polymer such as PEDOT: PSS. In some examples, additives may be included in the polymeric material that promote both flexibility and conductivity.

In some examples, the deformable layer 120 has a thickness of between about 5 nanometers to about 100 nanometers. Thicknesses within the range are believed to promote stress mitigation while maintaining sufficient transport interaction between the anode-side current collector 110 and the lithium metal.

The electrolyte 130 may be formed of various materials including those in the art for lithium-ion liquid electrolyte and lithium-ion solid-state electrolyte (SSEs). In some examples, the electrolyte 130 may be a lithium salt solution (e.g., lithium hexafluorophosphate (LiPF₆). For examples that use a liquid electrolyte, the lithium-ion cell may include a separator (e.g., a polyolefin film). In some examples, the electrolyte 130 may be an oxide-based SSE. In some examples, the electrolyte 130 may be an SSE formed of or including a garnet-type Li-ion conducting material (LLMO) that includes a composition comprising lithium, lanthanum, oxygen, and one of zirconium, niobium, or tantalum (i.e., M is Zr, Nb, or Ta). As specific example, the electrolyte 130 may be an SSE that includes or is formed of Li₇La₃Zr₂O₁₂ (LLZO).

The cathode 140 may be formed of various materials including those in the art for lithium-ion cathodes, including lithiated and nonlithiated cathodes. In some examples, the cathode 140 includes or is formed of a lithium intercalation material. In some examples, the cathode 140 includes or is formed of a lithium cobalt oxide, a lithium nickel manganese cobalt oxide (LiNiₓMn_{y}Co_{1-x-y}O₂; NMC) or a lithium nickel manganese oxide (spinel LiNi_{0.5}Mn_{1.5}O₄; LNMO). The cathode-side current collector 150 may be formed of various materials including those used in the art for lithium-ion cathode-side current collectors. In some examples, the cathode-side current collector 150 may include or be formed of aluminum or an alloy thereof.

The cathode-side current collector 150 may be formed of various materials including those used in the art for lithium-ion cathode-side current collectors. In some examples, the cathode-side current collector 150 may include or be formed of aluminum or an alloy thereof.

FIGS. 2 and 3 illustrate cycling of the lithium-ion cell 100 which is presented in a discharged and charged state, respectively. In the discharged state (FIG. 2), the deformable layer 120 and the electrolyte 130 are in contact and/or substantially proximate to each other. In the charged state (FIG. 3), a plated lithium layer 160 of lithium metal is between the deformable layer 120 and the electrolyte 130. The lithium-ion cell 100 may be repeatedly cycled (i.e., charged and/or discharged) to transition between the charged and discharged states. During a charging cycle, lithium-ions (Li+) from the cathode 140 are reduced, diffused through the electrolyte 130, and plated as lithium metal (LiO) on the deformable layer 120 to form the plated lithium layer 160. During a discharging cycle, the plated lithium metal is stripped from the deformable layer 120, diffused as lithium-ions through the electrolyte 130, and returned to the cathode 140.

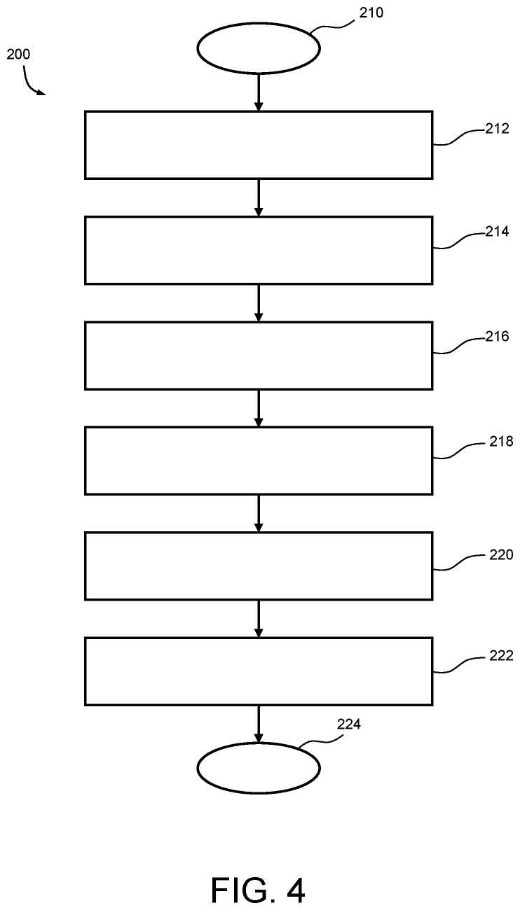

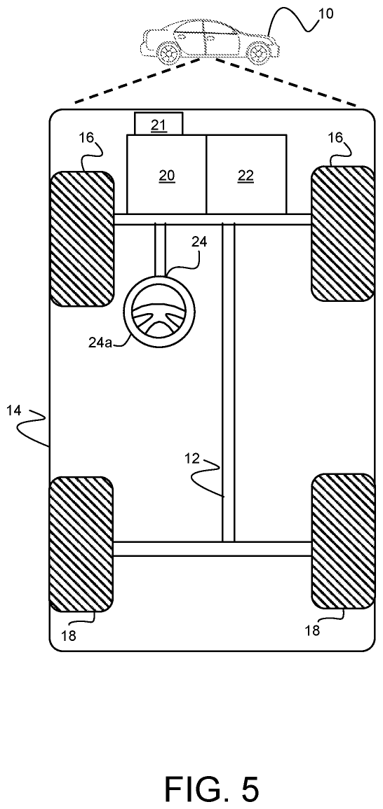

With reference now to FIG. 4 and with continued reference to FIGS. 1-3, a flowchart provides a method 200 for coating a current collector (e.g., the anode-side current collector 110) and forming a lithium-ion cell (e.g., the lithium-ion cell 100) in accordance with exemplary embodiments. As can be appreciated in light of the disclosure, the order of operation within the method 200 is not limited to the sequential execution as illustrated in FIG. 4, but may be performed in one or more varying orders as applicable and in accordance with the present disclosure.

In one example, the method 200 may start at 210. At 212, the method 200 may include providing, receiving, or forming a current collector (e.g., the anode-side current collector 110). Processes for forming the current collector are known in the art and will not be described in detail herein. The current collector may include or be formed of various materials including those discussed previously in relation to the anode-side current collector 110.

At 214, the method 200 may include forming a deformable layer (e.g., the deformable layer 120) on a surface of the current collector. The deformable layer is lithium-ion conductive and includes a polymeric material. The deformable layer may be formed by various processes. In some examples, the deformable layer may be formed by depositing the polymeric material onto the surface of the current collector by a spin coating, spraying, roll coating, or slot-die coating process. In such examples, the method 200 may include controlling the thickness of the deformable layer by controlling the viscosity and concentration of the polymeric material and controlling, during the spin coating or spraying process, a rotational speed of the current collector and a duration of deposition of the polymeric material. In some alternative examples, the deformable layer may be formed by depositing the polymeric material onto the surface of the current collector by an electroplating process. In such examples, the method 200 may include controlling the thickness of the deformable layer by controlling the charge per unit area during the electroplating process.

At 216, the method 200 may include forming a lithium metal layer (e.g., the initial lithium metal layer 180) on the deformable layer to define a lithium metal anode that includes the current collector, the deformable layer, and the lithium metal layer. In some examples, the lithium metal may be, for example, a thin film located between the deformable layer and the current collector. In such examples, a pressing process may be performed to form the lithium metal anode.

At 218, the method 200 may include providing, receiving, or forming an electrolyte (e.g., the electrolyte 130). Processes for forming the electrolyte are known in the art and will not be described in detail herein. In some examples, the electrolyte may be a liquid electrolyte. In some examples, the electrolyte may be an SSE. For example, the electrolyte may include or be formed of various materials including those discussed previously in relation to the electrolyte 130.

At 220, the method 200 may include providing, receiving, or forming a cathode (e.g., the cathode 140). Processes for forming the cathode are known in the art and will not be described in detail herein. The cathode may include or be formed of various materials including those discussed previously in relation to the cathode 140.

At 222, the method 200 may include assembling the lithium metal anode and the cathode with the electrolyte between the lithium metal anode and the cathode to define a lithium-ion cell (e.g., the lithium-ion cell 100). The method 200 may end at 224.

With reference now to FIG. 6, a vehicle 10 is provided according to an exemplary embodiment. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain examples.

As depicted in FIG. 6, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20, a transmission system 22, a steering system 24, and at least one lithium-ion battery 21. The propulsion system 20 includes an electric motor or a hybrid electric motor and combustion engine. The transmission system 22 is configured to transmit power from the propulsion system 20 to the wheels 16-18 according to selectable speed ratios. According to various examples, the transmission system 22 may include a step-ratio automatic transmission, a continuously-variable transmission, or other appropriate transmission. The steering system 24 influences a position of the wheels 16-18. While depicted as including a steering wheel for illustrative purposes, in some examples contemplated within the scope of the present disclosure, the steering system 24 may not include a steering wheel. The propulsion system 20 receives electrical power from the at least one lithium-ion battery 21 suitable for powering operation of the propulsion system 20 and/or components thereof (e.g., the electric motor). The lithium-ion battery 21 may include one or more lithium-ion cells such as the lithium-ion cell 100 of FIGS. 1-3.

The lithium-ion cells, batteries, and methods disclosed herein provide various benefits over certain existing lithium-ion cells, batteries, and methods. For example, cycling of lithium-ion cells may produce interfacial compressive stresses between the SEI layer and the current collector that can damage or rupture the SEI layer resulting in holes therein. Such holes may function as passages that promote formation of lithium dendrites that can deteriorate performance of lithium-ion cells due, for example, to consumption of electrolyte, and an increased likelihood of soft short circuits. In the present example, the deformable layer 120 reduces local concentrations of interfacial compressive stress acting upon the SEI layer 170 and thereby reduces a likelihood of damage the SEI layer 170 which in turn may reduce the likelihood of forming lithium dendrites. As such, the presence of the deformable layer 120 may promote reduced lithium inventory loss, improved cycle life, improved cell performance, and extended usable life span.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A lithium-ion cell, comprising;
a lithium metal anode that includes:
a current collector;
a deformable layer on a surface of the current collector, wherein the deformable layer is lithium-ion conductive and includes a polymeric material; and
a cathode having a lithium intercalation material; and
an electrolyte between the lithium metal anode and the cathode,

2. The lithium-ion cell of claim 1, wherein the lithium-ion cell is a hostless cell wherein lithium metal is plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte, wherein the deformable layer is configured to reduce interfacial stress acting upon the SEI layer during cycling of the lithium-ion cell.

3. The lithium-ion cell of claim 2, wherein the deformable layer has a Young's modulus that is less than a Young's modulus of the SEI layer that forms during charge of the lithium-ion cell.

4. The lithium-ion cell of claim 1, wherein the deformable layer has a thickness of between 5 nanometers to 100 nanometers.

5. The lithium-ion cell of claim 1, wherein the deformable layer includes polyamide, polyaniline (PANI), polythiophene (PTH), polypyrrole (PPy), polyesters, polyethylenes, a derivative of nitrile butadiene rubber, poly(3,4-ethylenedioxythiophene) (PEDOT), poly(3,4-ethylenedioxythiophene):poly(styrenesulfonate) (PEDOT:PSS), polyphenylene sulfides, polycarbonate, or acrylonitrile butadiene styrene that have been modified by the addition of conductive particles.

6. The lithium-ion cell of claim 1, wherein the deformable layer includes a conductive polymer hydrogel.

7. The lithium-ion cell of claim 1, wherein the deformable layer includes polyvinylidene fluoride (PVDF) with carbon nanotubes (CNT), styrene-butadiene rubber (SBR) with CNT, or poly(di-methylsiloxane) (PDMS), polyurethane (PU), polyacrylic acid (PAA) with conductive nanofillers such as metallic nanowires, carbon black, metallic nanoparticles, CNTs, graphene, or conducting polymeric particles.

8. The lithium-ion cell of claim 1, wherein the deformable layer includes a compound with two or more —OH groups and/or an elastomer in a concentration sufficient to promote mechanical stretchability of the polymeric material.

9. A method, comprising:
forming a lithium metal anode that includes a deformable layer on and in contact with a surface of a current collector, wherein the deformable layer is lithium-ion conductive and includes a polymeric material; and
assembling the lithium metal anode with a cathode having a lithium intercalation material and an electrolyte between the lithium metal anode and the cathode to define a lithium-ion cell.

10. The method of claim 9, wherein forming the deformable layer on the current collector includes depositing the polymeric material onto the surface of the current collector by a spin coating or spraying process.

11. The method of claim 10, further comprising controlling the thickness of the deformable layer by controlling the viscosity and concentration of the polymeric material and controlling, during the spin coating or spraying process, a rotational speed of the current collector and a duration of deposition of the polymeric material.

12. The method of claim 9, wherein forming the deformable layer on the current collector includes depositing the polymeric material onto the surface of the current collector by an electroplating process.

13. The method of claim 12, further comprising controlling the thickness of the deformable layer by controlling the charge per unit area during the electroplating process.

14. The method of claim 9, wherein the lithium-ion cell is configured to have lithium metal plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte, wherein the deformable layer has a Young's modulus that is less than a Young's modulus of the SEI layer that forms during charge of the lithium-ion cell.

15. The method of claim 9, wherein the deformable layer has a thickness of between 5 nanometers to 100 nanometers.

16. The method of claim 9, wherein the deformable layer includes polyamide, polyaniline (PANI), polythiophene (PTH), polypyrrole (PPy), polyesters, polyethylenes, a derivative of nitrile butadiene rubber, poly(3,4-ethylenedioxythiophene) (PEDOT), poly(3,4-ethylenedioxythiophene):poly(styrenesulfonate) (PEDOT:PSS), polyphenylene sulfides, polycarbonate, or acrylonitrile butadiene styrene that have been modified by the addition of conductive particles.

17. The method of claim 9, wherein the deformable layer includes a conductive polymer hydrogel.

18. The method of claim 9, wherein the deformable layer includes polyvinylidene fluoride (PVDF) with carbon nanotubes (CNT), styrene-butadiene rubber (SBR) with CNT, or poly(di-methylsiloxane) (PDMS), polyurethane (PU), polyacrylic acid (PAA) with conductive nanofillers such as metallic nanowires, carbon black, metallic nanoparticles, CNTs, graphene, or conducting polymeric particles.

19. The method of claim 9, wherein the deformable layer includes a compound with two or more-OH groups and/or an elastomer in a concentration sufficient to promote mechanical stretchability of the polymeric material.

20. A vehicle, comprising:
a lithium-ion battery including a lithium-ion cell, wherein the lithium-ion cell includes:
a lithium metal anode that includes:
a current collector; and
a deformable layer on a surface of the current collector, wherein the deformable layer is lithium-ion conductive and includes a polymeric material;
a cathode having a lithium intercalation material; and
an electrolyte between the lithium metal anode and the cathode,
wherein lithium metal is plated on the deformable layer during charge of the lithium-ion cell to define a plated lithium layer between the deformable layer and the electrolyte, and a solid electrolyte interphase (SEI) layer forms on the plated lithium layer separating the plated lithium layer from the electrolyte, wherein the deformable layer has a Young's modulus that is less than a Young's modulus of the SEI layer that forms during charge of the lithium-ion cell, wherein the deformable layer has a thickness of between 5 nanometers to 100 nanometers,
wherein the deformable layer is configured to reduce interfacial stress acting upon the SEI layer during cycling of the lithium-ion cell; and
a propulsion system configured to receive electric power from the lithium-ion battery.
